(19) United States
(12) Patent Application Publication
(10) Pub. No.: US 2011/0168761 A1
(43) Pub. Date: Jul. 14, 2011

(54) APPARATUS FOR REPAIRING SEMICONDUCTOR MODULE

(75) Inventors: Sun-kyu Hwang, Asan-si (KR); Seong-chan Han, Cheonan-si (KR); Kwang-ho Chun, Cheonan-si (KR); Jung-hoon Kim, Asan-si (KR); Dong-su Han, Suwon-si (KR)

(73) Assignee: Samsung Electronics Co., Ltd., Suwon-si (KR)

(21) Appl. No.: 12/987,550

(22) Filed: Jan. 10, 2011

(30) Foreign Application Priority Data
Jan. 11, 2010 (KR) 1020100002380

(51) Int. Cl. B23K 1/018

(52) U.S. Cl. 228/13

(57) ABSTRACT

An apparatus for repairing a semiconductor module including: a heating block comprising a thermal contact surface for contacting a defective semiconductor package mounted on a substrate of the semiconductor module to heat the defective semiconductor package using a conduction method and to melt a solder of the defective semiconductor package, and a vacuum adsorption line for adsorbing the defective semiconductor package and separating the defective semiconductor package from the substrate; and a heater installed in the heating block.

### CROSS-REFERENCE TO RELATED APPLICATIONS

This application claims the benefit of Korean Patent Application No. 10-2010-0002380, filed on Jan. 11, 2010, in the Korean Intellectual Property Office, the disclosure of which is incorporated herein in its entirety by reference.

### BACKGROUND

The inventive concept relates to an apparatus for repairing a semiconductor module, and more particularly to, an apparatus for repairing a semiconductor module capable of minimizing thermal damage to a peripheral semiconductor package when a defective semiconductor package is separated from the semiconductor module and a new semiconductor package is mounted thereon.

A semiconductor module, for example, a semiconductor memory device, includes a plurality of semiconductor packages mounted on a printed circuit board (PCB). The semiconductor module often includes a defective semiconductor package during a test process.

A repair process may replace a defective semiconductor package among a plurality of semiconductor packages mounted on the semiconductor module with a new semiconductor package in order for the semiconductor module to operate normally.

Semiconductor repair apparatuses are used to melt a solder of a defective semiconductor package in order to separate the defective semiconductor package from the PCB or to mount a new semiconductor package to the PCB.

Meanwhile, while separating the defective semiconductor package from the PCB during the semiconductor repair process, a normal semiconductor package may be damaged.

Such damage is caused from a severe change in a thermal environment that often occurs during the semiconductor repair process. In particular, while melting the solder of the defective semiconductor package, the severe change in the thermal environment often occurs in normal semiconductor packages around the defective semiconductor package.

In addition, it has been recently proved that thermal damage caused by the severe change in the thermal environment remains unchanged even when the thermal environment is restored to normal, thermal damage accumulates with each subsequent process. Even after a normal semiconductor package is released, a user may cause the normal semiconductor package to malfunction when thermal damage accumulates over a maximum amount due to even small repeated changes in the thermal environment. Thus, minimization of thermal damage is recently of great importance.

Furthermore, thermal damage to a semiconductor package is severe at a temperature higher than an indoor temperature and is quite weak at a temperature lower than the indoor temperature.

### SUMMARY

The inventive concept provides an apparatus for repairing a semiconductor module capable of minimizing thermal damage to peripheral semiconductor packages by using a heating block that contacts a defective semiconductor package and by completely preventing thermal damage from spreading to peripheral semiconductor packages by cooling the peripheral semiconductor packages using a cooling gas spray nozzle or a heat absorbent.

The inventive concept also provides an apparatus for repairing a semiconductor module using a hybrid method including a conduction method that uses a contact type heating block to melt a solder of a defective semiconductor package and a convection method that uses a heating gas spray nozzle used to melt a remaining solder of the defective semiconductor package, thereby greatly reducing a processing time and increasing productivity and reliability.

The inventive concept also provides an apparatus for repairing a semiconductor module capable of blocking another semiconductor package from heating gas by using a blocking wall to prevent thermal damage from. occurring.

According to an aspect of the inventive concept, there is provided an apparatus for repairing a semiconductor module including: a heating block comprising a thermal contact surface for contacting a defective semiconductor package mounted on a substrate of the semiconductor module to heat the defective semiconductor package using a conduction method and to melt a solder of the defective semiconductor package, and a vacuum adsorption line for adsorbing the defective semiconductor package in which the solder is melted and separating the defective semiconductor package from the substrate; and a heater installed in the heating block.

A vacuum adsorption hole of the vacuum adsorption line may be formed in a portion of the thermal contact surface.

The apparatus may further include: a cooling device for cooling a semiconductor package which is adjacent to the defective semiconductor package to prevent the semiconductor package from being thermally damaged.

The cooling device may include a cooling gas spray nozzle installed in a frame on which the substrate is seated and spraying cool gas in a direction facing the semiconductor package to cool the semiconductor package.

The cooling device may include a heat absorbent for contacting the semiconductor package to cool the semiconductor package.

The apparatus may further include: a heating gas spray nozzle for spraying heating gas toward a remaining solder on the substrate from which the defective semiconductor package is removed.

The apparatus may further include: a remaining solder removing device for removing the remaining solder melted by the heating gas sprayed by the heating gas spray nozzle.

The apparatus may further include: a transfer block comprising a contact surface for contacting a new semiconductor package and a vacuum adsorption line, adsorbing the new semiconductor package, and transferring the adsorbed new semiconductor package to the substrate to mount the new semiconductor package on the substrate from which the defective semiconductor package is removed.

According to another aspect of the inventive concept, there is provided an apparatus for repairing a semiconductor module including: a solder melting device for melting a solder of a defective semiconductor package mounted on a substrate of the semiconductor module to separate the defective semiconductor package from the substrate; and a cooling device for cooling a semiconductor package which is adjacent to the defective semiconductor package melted by the solder melting device to prevent the semiconductor package from being thermally damaged.

The solder melting device may include: a heating block comprising a thermal contact surface for contacting the defective semiconductor package, and a vacuum adsorption line for adsorbing the defective semiconductor package having a melted solder and separating the defective semiconductor package from the substrate; and a heater installed in the heating block and for heating the heating block.

The cooling device may include a cooling gas spray nozzle installed in a frame on which the substrate is seated and spraying cool gas in a direction facing the semiconductor package to cool the semiconductor package.

The apparatus may further include: a blocking wall for blocking cooling gas sprayed from the cooling gas spray nozzle to preserve heat applied to the defective semiconductor package.

The cooling gas spray nozzle may include: an upper cooling gas spray nozzle installed above an upper surface of the substrate and for spraying cooling gas toward the semiconductor package; and a lower cooling gas spray nozzle installed below a lower surface of the substrate and for spraying cooling gas toward the semiconductor package.

The cooling device may include a heat absorbent for contacting the semiconductor package to cool the semiconductor package.

### BRIEF DESCRIPTION OF THE DRAWINGS

Exemplary embodiments of the inventive concept will be more clearly understood from the following detailed description taken in conjunction with the accompanying drawings in which:

FIG. 1 is a cross-sectional view for explaining an operation of removing a defective semiconductor package performed by an apparatus for repairing a semiconductor module according to an embodiment of the inventive concept;

FIG. 2 is a cross-sectional view for explaining an operation of removing a remaining solder performed by the apparatus for repairing the semiconductor module of FIG. 1;

FIG. 3 is a cross-sectional view for explaining an operation of mounting a new semiconductor package performed by the apparatus for repairing the semiconductor module of FIG. 1;

FIG. 4 is an enlarged cross-sectional view of a cooling device of the apparatus for repairing the semiconductor module of FIG. 1 according to an embodiment of the inventive concept;

FIG. 5 is an enlarged cross-sectional view of a cooling device of the apparatus for repairing the semiconductor module of FIG. 1 according to another embodiment of the inventive concept; and

FIG. 6 is an enlarged cross-sectional view of a blocking wall of an apparatus for repairing a semiconductor module according to another embodiment of the inventive concept.

### DETAILED DESCRIPTION OF THE EMBODIMENTS

The inventive concept will now be described more fully with reference to the accompanying drawings, in which exemplary embodiments of the inventive concept are shown. In the drawings, the same reference numerals denote the same elements.

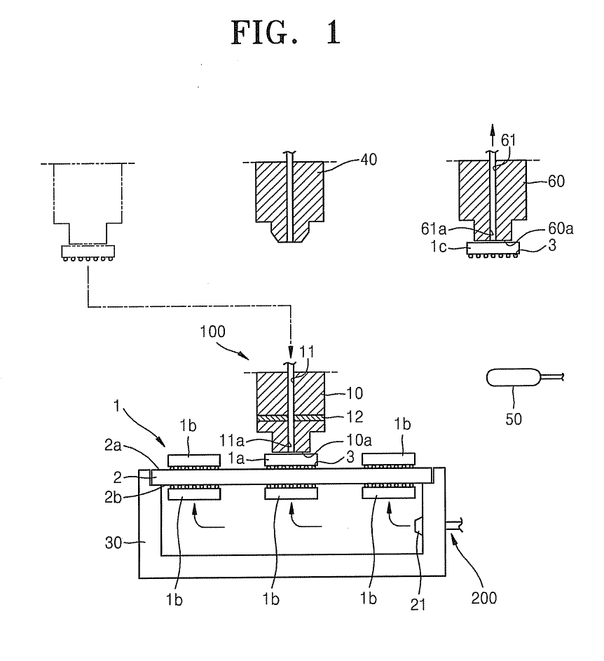

FIG. 1 is a cross-sectional view for explaining an operation of removing a defective semiconductor package 1a performed by an apparatus for repairing a semiconductor module 1 according to an embodiment of the inventive concept.

Referring to FIG. 1, the apparatus for repairing the semiconductor module 1 includes a solder melting device 100 including a heating block 10, a cooling device 200, a heating gas spray nozzle 40, a remaining solder removing device 50, and a transfer block 60.

The heating block 10 may melt a solder 3 of the defective semiconductor package 1a using a conduction method.

In more detail, the heating block 10 includes a thermal contact surface 10a that contacts the defective semiconductor package 1a mounted on a surface 2a of the substrate 2 in order to heat the defective semiconductor package 1a using the conduction method and to melt the solder 3 of the defective semiconductor package 1a.

Therefore, the defective semiconductor package 1a contacts the thermal contact surface 10a of the heating block 10 and is heated using the conduction method. Then the solder 3 disposed between the defective semiconductor package 1a and the substrate 2 to connect the defective semiconductor package 1a to the substrate 2 is melted by heat conducted from the defective semiconductor package 1a, and thus the defective semiconductor package 1a is freely separated from the substrate 2.

A vacuum adsorption line 11 is installed in the heating block 10 to adsorb the defective semiconductor package 1a freely separated from the substrate 2 after the solder 3 is melted, to lift the adsorbed defective semiconductor package 1a up, and to move the defective semiconductor package 1a away from the substrate 2.

A vacuum adsorption hole 11a of the vacuum adsorption line 11 is formed in a portion of the thermal contact surface 10a.

The thermal contact surface 10a contacts the defective semiconductor package 1a and simultaneously forms a vacuum adsorption surface that contacts the defective semiconductor package 1a.

A heater 12 that heats the heating block 10 or the thermal contact surface 10a may be installed in the heating block 10.

A variety of types and shapes of heat transfer devices that generate heat using, for example, electricity, such as flat type pyrogens or heat line type or coil type pyrogens, may be used as the heater 12.

Meanwhile, the cooling device 200 cools a semiconductor package 1b which is adjacent to the defective semiconductor package 1a to prevent the semiconductor package 1b from being thermally damaged due to the defective semiconductor package 1a being heated by the heating block 10.

The cooling device 200 may include a cooling gas spray nozzle 21 that is installed inside a frame 30 on which the substrate 2 is seated and that sprays cooling gas toward the semiconductor package 1b in order to cool the semiconductor package 1b.

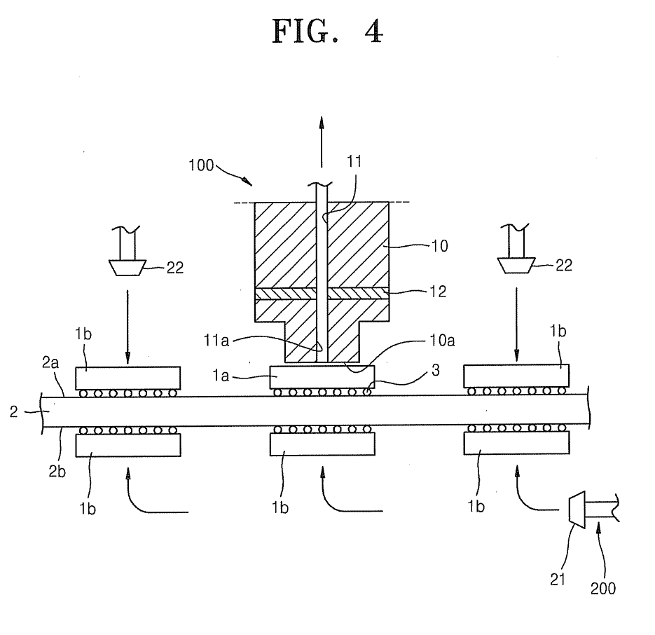

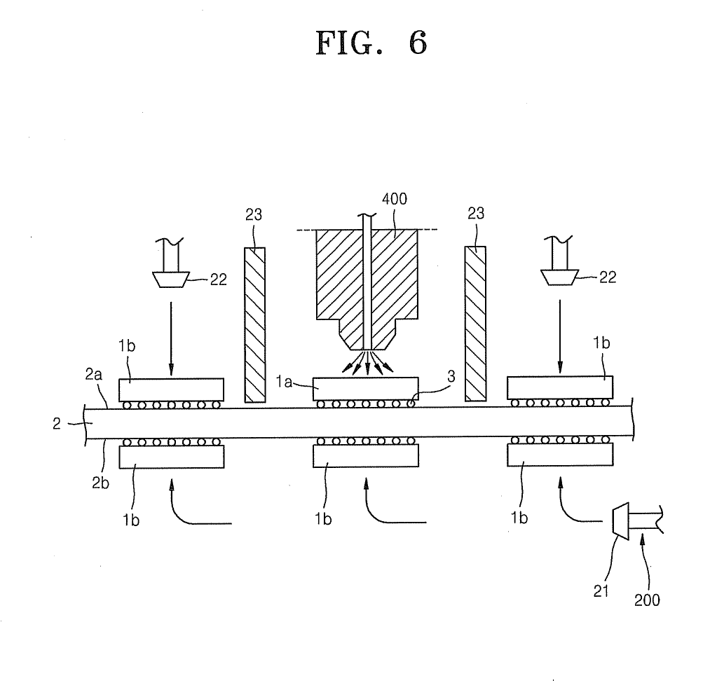

The cooling gas spray nozzle 21 may be a lower cooling gas spray nozzle that is installed under a lower surface 2b of the substrate 2 and sprays cooling gas toward the semiconductor package 1b, as illustrated in FIG. 1. Instead, the cooling gas spray nozzle 21 may be an upper cooling gas spray nozzle 22 that is installed above the upper surface 2a of the substrate 2 and sprays cooling gas toward the semiconductor package 1b, as illustrated in FIGS. 4 and 6.

Therefore, the cooling device 200 may prevent the semiconductor package 1b from being heated due to a conduction via the substrate 2 while the defective semiconductor package 1a is heated by the heating block 10.

In addition, although thermal damage is severe at a temperature higher than the room temperature, since thermal damage is quite weak at a temperature lower than the room temperature, thermal damage rarely occurs to the semiconductor package 1b when the semiconductor package 1b adjacent to the defective semiconductor package 1a is extremely cooled.

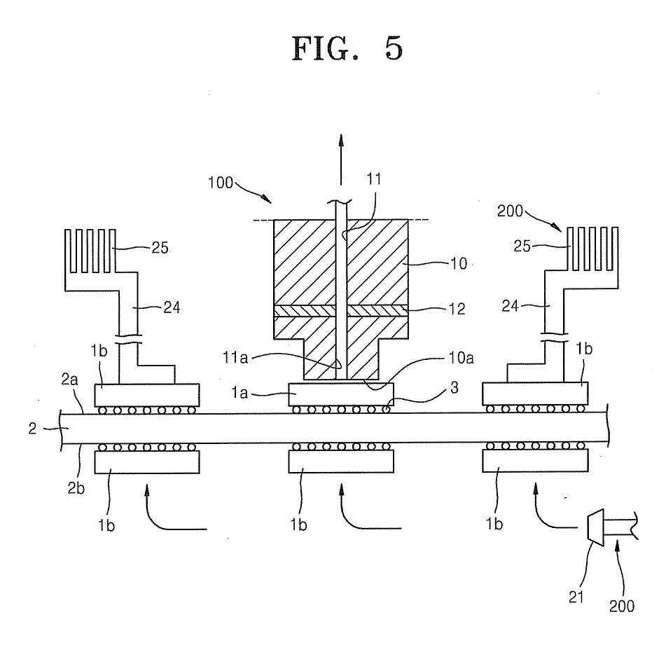

FIG. 5 is an enlarged cross-sectional view of the cooling device 200 of the apparatus for repairing the semiconductor module 1 of FIG. 1 according to another embodiment of the inventive concept.

Referring to FIG. 5, the cooling device 200 may include a heat absorbent 24 that contacts the semiconductor package 1b to cool the semiconductor package 1b, in addition to the cooling gas spray nozzles 21 and 22.

The heat absorbent 24 contacts the semiconductor package 1b adjacent to the defective semiconductor package 1a and absorbs heat to prevent the temperature of the semiconductor package 1b from increasing. An air cooling type dissipation pin 25 may be formed on the heat absorbent 24, or various types of thermal medium cycling type cooling devices (not shown), such as a chiller or a freezing cycler, may be used as the heat absorbent 24.

Thus, while the defective semiconductor package 1a is heated by the heating block 10, the heat absorbent 24 contacts the normal semiconductor package 1b adjacent to the defective semiconductor package 1a and cools the semiconductor package 1b, thereby preventing the semiconductor package 1b from being heated due to a conduction via the substrate 2.

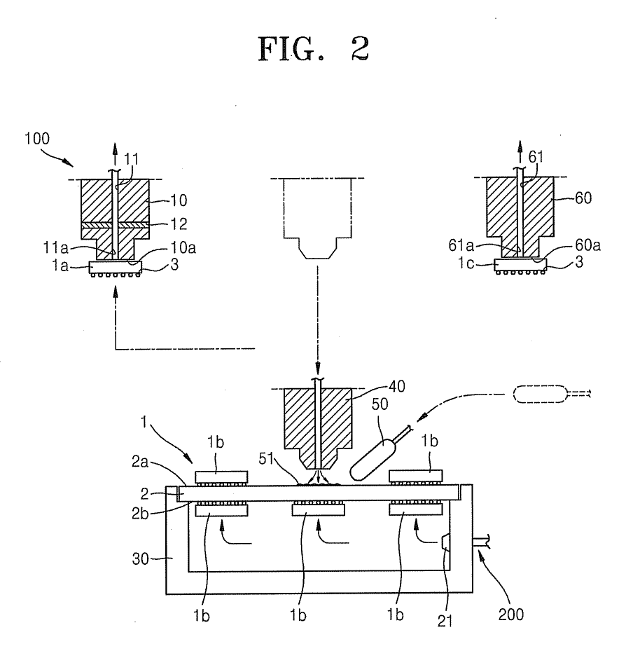

Subsequent to the operation of removing the defective semiconductor package 1a of FIG. 1, FIG. 2 is a cross-sectional view for explaining an operation of removing a remaining solder 51 performed by the apparatus for repairing the semiconductor module 1 of FIG. 1.

Referring to FIG. 2, the heating gas spray nozzle 40 melts the remaining solder 51 using a convection method.

In more detail, the heating gas spray nozzle 40 sprays heating gas toward the remaining solder 51 in order to melt the remaining solder 51 of the substrate 2 separated from the defective semiconductor package 1a.

The remaining solder removing device 50 may remove the remaining solder 51 melted by the heating gas sprayed by the heating gas spray nozzle 40 and may include a solder absorbent, namely a wicker, that absorbs the remaining solder 51.

Thus, the remaining solder 51 of the substrate 2 from which the defective semiconductor package 1a is removed may be melted by the heating gas sprayed by the heating gas spray nozzle 40 and the melted remaining solder 51 may be absorbed by the solder absorbent, thereby cleaning the upper surface 2a of the substrate 2.

Various shapes of solder absorbing devices for removing the remaining solder 51 may be used as the remaining solder removing device 50, in addition to the solder absorbent.

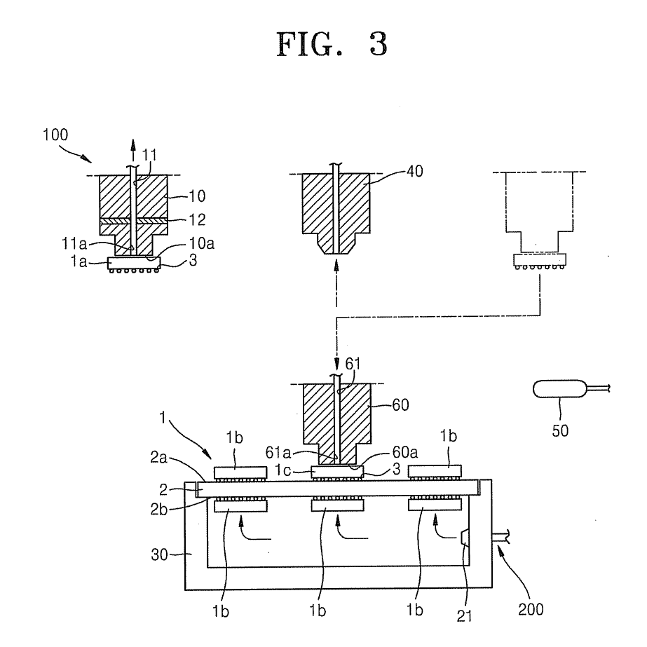

Subsequent to the operation of removing the remaining solder 51 of FIG. 2, FIG. 3 is a cross-sectional view for explaining an operation of mounting a new semiconductor package 1c performed by the apparatus for repairing the semiconductor module 1 of FIG. 1.

Referring to FIG. 3, a contact surface 60a that contacts the new semiconductor package 1c is formed on the transfer block 60 in order to mount the new semiconductor package 1c on the substrate 2 from which the defective semiconductor package 1a is removed.

A vacuum adsorption line 61 may be installed in the transfer block 60 to adsorb the new semiconductor package 1c and transfer the new semiconductor package 1c to the substrate 2.

A vacuum adsorption hole 61a of the vacuum adsorption line 61 may be formed on a portion of the contact surface 60a.

Thus, the transfer block 60 adsorbs the new semiconductor package 1c and stands by in a waiting place until the defective semiconductor package 1a is removed using the solder melting device 100 including the heating block 10 as shown in FIG. 1 and the remaining solder 51 is removed from the substrate 2 using the heating gas spray nozzle 40 by using the remaining solder removing device 50 as shown in FIG. 2, and transfers and mounts the new semiconductor package 1c on the substrate 2 from which the remaining solder 51 is removed as shown in FIG. 3.

The solder 3 is melted onto or pasted on the new semiconductor package 1c and hardened after the new semiconductor package 1c is seated on the substrate 2, so that the new semiconductor package 1c is firmly mounted on the substrate 2.

A solder that melts at a high temperature or a solder that remains in a paste state at a room temperature and that hardens after a volatile material thereof is entirely volatilized may be used as the solder 3. Any of various types of conductive hardening materials may be applied as the solder 3.

FIG. 6 is an enlarged cross-sectional view of a blocking wall 23 of an apparatus for repairing a semiconductor module according to another embodiment of the inventive concept.

Referring to FIG. 6, the apparatus for repairing the semiconductor module may further include the blocking wall 23, which blocks cooling gas sprayed from the cooling gas spray nozzle 22, in order to preserve heat applied to the defective semiconductor package 1a.

When a heating gas spray nozzle 400 sprays heating gas onto the defective semiconductor package 1a, the blocking wall 23 prevents cooling gas and heating gas from being mixed, prevents interference by cooling gas when the solder 3 of the defective semiconductor package la is melted, and prevents the semiconductor package 1b from being thermally damaged due to the heating gas.

Thus, the blocking wall 23 is installed in the heating gas spray nozzle 400 so that the heating gas spray nozzle 400 sprays heating gas only onto the defective semiconductor package 1a or the remaining solder 51, thereby blocking the heating gas from adversely affecting the semiconductor package 1b.

A heating block that contacts a defective semiconductor package is used to minimize thermal damage to another semiconductor package, and a cooling gas spray nozzle, a heat absorbent, or a blocking wall is used to completely prevent another semiconductor package from being thermally damaged, and a hybrid method including both a conduction method that uses a contact type heating block and a convection method that uses a heating gas spray nozzle used to melt a remaining solder is used to achieve optimal processing speed and productivity.

While the inventive concept has been particularly shown and described with reference to exemplary embodiments thereof, it will be understood that various changes in form and details may be made therein without departing from the spirit and scope of the following claims. Accordingly, the scope of the inventive concept is defined by the appended claims.

What is claimed is:

1. An apparatus for repairing a semiconductor module comprising:
a heating block comprising a thermal contact surface for contacting a defective semiconductor package mounted on a substrate of the semiconductor module to heat the defective semiconductor package using a conduction method and to melt a solder of the defective semiconductor package, and a vacuum adsorption line for adsorbing the defective semiconductor package in which the solder is melted and separating the defective semiconductor package from the substrate; and
a heater installed in the heating block.

2. The apparatus of claim 1, wherein a vacuum adsorption hole of the vacuum adsorption line is formed in a portion of the thermal contact surface.

3. The apparatus of claim 1, further comprising: a cooling device for cooling a semiconductor package which is adjacent to the defective semiconductor package to prevent the semiconductor package from being thermally damaged.

4. The apparatus of claim 3, wherein the cooling device comprises a cooling gas spray nozzle installed in a frame on which the substrate is seated and spraying cooling gas toward the semiconductor package to cool the semiconductor package.

5. The apparatus of claim 4, wherein the cooling gas spray nozzle comprises:
an upper cooling gas spray nozzle installed above an upper surface of the substrate and for spraying cooling gas toward the semiconductor package; and
a lower cooling gas spray nozzle installed below a lower surface of the substrate and for spraying cooling gas toward the semiconductor package.

6. The apparatus of claim 3, wherein the cooling device comprises a heat absorbent for contacting the semiconductor package to cool the semiconductor package.

7. The apparatus of claim 1, further comprising: a heating gas spray nozzle for spraying heating gas toward a remaining solder on the substrate from which the defective semiconductor package is removed.

8. The apparatus of claim 7, further comprising: a remaining solder removing device for removing the remaining solder melted by the heating gas sprayed by the heating gas spray nozzle.

9. The apparatus of claim 8, wherein the remaining solder removing device comprises a solder absorbing device for absorbing the remaining solder.

10. The apparatus of claim 1, further comprising: a transfer block comprising a contact surface for contacting a new semiconductor package and a vacuum adsorption line, adsorbing the new semiconductor package, and transferring the adsorbed new semiconductor package to the substrate to mount the new semiconductor package on the substrate from which the defective semiconductor package is removed.

11. An apparatus for repairing a semiconductor module comprising:
a solder melting device for melting a solder of a defective semiconductor package mounted on a substrate of the semiconductor module to separate the defective semiconductor package from the substrate; and
a cooling device for cooling a semiconductor package which is adjacent to the defective semiconductor package heated by the solder melting device to prevent the semiconductor package from being thermally damaged.

12. The apparatus of claim 11, wherein the solder melting device comprises:
a heating block comprising a thermal contact surface for contacting the defective semiconductor package, and a vacuum adsorption line for adsorbing the defective semiconductor package having a melted solder and separating the defective semiconductor package from the substrate; and
a heater installed in the heating block and for heating the heating block.

13. The apparatus of claim 11, wherein the cooling device comprises a cooling gas spray nozzle installed in a frame on which the substrate is seated and spraying cooling gas toward the semiconductor package to cool the semiconductor package.

14. The apparatus of claim 13, further comprising: a blocking wall for blocking cooling gas sprayed from the cooling gas spray nozzle to preserve heat applied to the defective semiconductor package.

15. The apparatus of claim 13, wherein the cooling gas spray nozzle comprises:
an upper cooling gas spray nozzle installed above an upper surface of the substrate and for spraying cooling gas toward the semiconductor package; and
a lower cooling gas spray nozzle installed below a lower surface of the substrate and for spraying cooling gas toward the semiconductor package.

16. The apparatus of claim 11, wherein the cooling device comprises a heat absorbent for contacting the semiconductor package to cool the semiconductor package.
